(19) United States
(12) Patent Application Publication
(10) Pub. No.: US 2021/0178734 A1
(43) Pub. Date: Jun. 17, 2021

(54) FOAMED SHEET, ELECTRIC OR ELECTRONIC DEVICE, AND DEVICE WITH TOUCH SCREEN

(71) Applicant: NITTO DENKO CORPORATION, ibaraki-shi, Osaka (JP)

(72) Inventors: Kazumichi KATO, Ibaraki-shi, Osaka (JP); Hideyuki TOKUYAMA, Ibaraki-shi, Osaka (JP)

(21) Appl. No.: 16/322,776

(22) PCT Filed: Jul. 6, 2017
(86) PCT No.: PCT/JP2017/024785

§ 371 Date: Feb. 1, 2019

(30) Foreign Application Priority Data
Aug. 1, 2016 (JP) 2016-151180
Jul. 3, 2017 (JP) 2017-130712

(51) Int. Cl. B32B 27/06; G06F 3/041; C08J 9/30

(52) U.S. Cl. CPC B32B 27/065; C08J 9/30; G06F 3/0412

(57) ABSTRACT

There is provided a foamed sheet having the excellent impact absorbability and the excellent resistance to repetitive impacts. The foamed sheet of the present invention has an average cell diameter of 10 to 200 μm, a resiliency of 6.0 N/cm² or less when compressed to 50% of an original thickness thereof, and a thickness recovery rate defined by the following equation of 90% or more:

thickness recovery rate (%)=(thickness 0.5 seconds after compressed state is released)/(original thickness)×100
original thickness: a thickness of the foamed sheet before a load is applied,
thickness 0.5 seconds after compressed state is released: a thickness of the foamed sheet after a compressed state in which a load of 100 g/cm² is applied to the foamed sheet is kept for 120 seconds followed by release of the foamed sheet from the compression and an elapse of 0.5 seconds from the release.

### TECHNICAL FIELD

The present invention relates to a foamed sheet, an electric or electronic device, and a device with touch screen. More specifically, the present invention relates to a foamed sheet, an electric or electronic device using the foamed sheet, and a device with touch screen using the foamed sheet.

### BACKGROUND ART

A foamed material is conventionally used for fixing an image display member or an optical member at a predetermined position (e.g., in a housing) in an image display device such as a liquid crystal display, an electroluminescence display, or a plasma display, or mounting a display member or an optical member such as a camera or a lens on a so-called “mobile phone”, “smartphone”, “personal digital assistant”, or the like at a predetermined position. As such a foamed material, a fine-cell urethane foam, which has been less expanded and has a closed cell structure, and a compaction molding product of a highly expanded urethane foam, as well as a polyethylene foam having closed cells and an expansion ratio of around 30 have been used. Specifically, there are used a gasket made of a polyurethane foam having a density of 0.3 to 0.5 g/cm³ (see Patent Literature 1) and a sealing material for an electric or electronic device that is a foamed structure having an average cell diameter of 1 to 500 μm (see Patent Literature 2), for example.

### CITATION LIST

### Patent Literature

### Patent Literature 1: JP2001-100216A

### Patent Literature 2: JP2002-309198A

### SUMMARY OF INVENTION

### Technical Problem

It is demanded that such a foamed material has impact absorbing properties when an impact is given thereon (impact absorbability). For example, a foamed sheet having excellent impact absorbability is used for an electric or electronic device equipped with a display member, such as a “smartphone”, in order to absorb an impact upon collision to thereby prevent breakage of the display member when the electric or electronic device falls to the ground or the like. As conventional foamed sheets having excellent impact absorbability have higher flexibility, they are also likely to have highly excellent impact absorbability, but tend to take much time to return to the original thickness thereof after released from an impact. Then, when repetitive impacts are given on conventional foamed sheets having excellent impact absorbability, they often exhibit poor resistance to repetitive impacts, since the foamed sheet undergoes a subsequent impact before thoroughly return to its original thickness to thereby fail to absorb the second and subsequent impacts enough. Therefore, a foamed sheet having excellent impact absorbability and also excellent resistance to repetitive impacts is needed.

Furthermore, with the spread of devices with touch screen such as a smartphone and a personal digital assistant in recent years, the finger and a stylus, such as a touch pen, of a user are frequently brought into contact with a display and also pressed on a display. Additionally, the reduction in the thickness of these devices with touch screen progresses remarkably, and then, the reduction in the thickness of members composing them (for example, a display panel exemplified by an LCD panel, and a touch screen sensing the point of contact) also progresses. Therefore, the display panel and a touch screen deflect very readily when a user press the display. If a flexure is generated, the display panel interferes with other members (e.g., a circuit board and a battery) inside due to the flexure, and display unevenness (a blur in a wave pattern) may be generated in the display panel. The cause of the generation of display unevenness is probably because the display panel is pressed on other members inside and thus subjected to a stress to result in disarrangement of the orientation of liquid crystal molecules.

To this problem of display unevenness (a blur in a wave pattern) that may be generated due to the stress applied to a display panel, the following approaches are suggested, for example: a gap is provided around the display panel so that a stress is unlikely to be applied to the display panel if it deforms; the design of the display panel or a touch screen is modified so that it has a large thickness so as not to deflect easily; and the rigidity of a housing of the device with touch screen is increased so that the housing is difficult to deform. However, these approaches involve adverse effects of increase in the thickness or weight of the device with touch screen. Thus, for devices with touch screen, there is a need to solve the problem of display unevenness (a blur in a wave pattern) that may occur due to the stress applied to a display panel while also addressing the remarkably progressing reduction in the thickness of these devices.

Therefore, an object of the present invention is to provide a foamed sheet having excellent impact absorbability and excellent resistance to repetitive impacts.

Another object of the present invention is to provide a foamed sheet that has excellent impact absorbability and excellent resistance to repetitive impacts and can highly inhibit the generation of display unevenness in a display member due to a user's touch operation when used in a device with touch screen.

Still another object of the present invention is to provide a foamed sheet having excellent properties described above even with a very small thickness.

Still another object of the present invention is to provide a foamed sheet that has the properties described above and also can prevent slippage even without a pressure-sensitive adhesive layer when laminated with another member.

### Solution to Problem

As a result of earnest studies to achieve the above objects, the present inventors have found that a foamed sheet has excellent impact absorbability and also excellent resistance to repetitive impacts which the formed sheet has an average cell diameter within a specific range, a resiliency of 6.0 N/cm² or less when compressed to 50% of an original thickness thereof, and a thickness recovery rate of 90% or more 0.5 seconds after compressed state under a specific load applied is released. The present invention has been completed based on these findings.

Specifically, the present invention provides a foamed sheet having an average cell diameter of 10 to 200 μm, a resiliency of 6.0 N/cm² or less when compressed to 50% of an original thickness thereof, and a thickness recovery rate defined by the following equation of 90% or more:

thickness recovery rate (%)=(thickness 0.5 seconds after compressed state is released)/(original thickness)×100

original thickness: a thickness of the foamed sheet before a load is applied,

thickness 0.5 seconds after compressed state is released: a thickness of the foamed sheet after a compressed state in which a load of 100 g/cm² is applied to the foamed sheet is kept for 120 seconds followed by release of the foamed sheet from the compression and an elapse of 0.5 seconds from the release.

The foamed sheet preferably has a thickness of 30 to 1000 μm and a density of 0.2 to 0.7 g/cm³.

The peak top of a loss tangent (tan δ) of the foamed sheet preferably appears within a range not less than −60° C. and not more than 20° C., wherein the tan δ is a ratio of a loss modulus to a storage modulus at an angular frequency of 1 rad/s in a dynamic viscoelasticity measurement.

The foamed sheet preferably has an increment of an impulsive force at a fifth collision from an impulsive force at a first collision of 5% or less, when an impacting object is allowed to collide five times continuously at one-second intervals against a substrate of a structure composed of the substrate and the foamed sheet in an impact absorption test using a pendulum impact testing machine.

The foamed sheet preferably comprises a crosslinking agent and a silicone compound.

The foamed sheet preferably has a content insoluble to methyl ethyl ketone as a solvent of 80% or more by weight.

The maximum value of the loss tangent (tan δ) of the foamed sheet within a range not less than −60° C. and not more than 20° C. is preferably 0.2 or more.

The foamed sheet preferably has a thickness recovery rate at a high temperature defined below of 50% or more:

thickness recovery rate at a high temperature: a ratio of a thickness 24 hours after releasing a compressed state at a high temperature to an original thickness, wherein the foamed sheet is compressed in an atmosphere at 80° C. in a thickness direction to 50% of the original thickness thereof and left for 22 hours, then left standing in an atmosphere at 23° C. for 2 hours, and then released from compression.

The foamed sheet is preferably a foamed sheet wherein an acrylic polymer is used as a resin material.

At least one side of the foamed sheet preferably has a shear adhesive strength (23° C., tension rate 50 mm/min) to a SUS304BA plate of 0.5 N/100 mm² or more.

The foamed sheet is preferably a mechanically foamed product of an emulsion resin composition.

The foamed sheet may have a pressure-sensitive adhesive layer on one or both of sides thereof.

The foamed sheet is preferably used as an impact absorbing sheet for an electric or electronic device.

The foamed sheet is preferably for use in a device with touch screen.

The present invention also provides an electric or electronic device having the foamed sheet.

The electric or electronic device preferably comprises a display member, wherein the electric or electronic device has a structure in which the foamed sheet is sandwiched between a housing of the electric or electronic device and the display member.

The present invention also provides a device with touch screen having the foamed sheet.

The device with touch screen preferably has the foamed sheet, a display panel, and a touch screen, wherein the foamed sheet is arranged in a space on a back side of the display panel.

### Advantageous Effect of Invention

The foamed sheet of the present invention has excellent impact absorbability and excellent resistance to repetitive impacts. The foamed sheet of present invention has excellent impact absorbability and excellent resistance to repetitive impacts and also can highly inhibit the generation of display unevenness in a display member due to a user's touch operation when used in a device with touch screen. Even with a very small thickness, the foamed sheet of present invention has excellent impact absorbability and excellent resistance to repetitive impacts and also can highly inhibit the generation of display unevenness in a display member due to a user's touch operation when used in a device with touch screen.

Furthermore, the foamed sheet of the present invention can have a structure capable of preventing slippage even without a pressure-sensitive adhesive layer when laminated with another member.

### BRIEF DESCRIPTION OF DRAWINGS

FIG. 1 is a schematic configuration diagram showing a pendulum impact testing machine (impact testing apparatus).

FIG. 2 is a diagram showing the schematic configuration of a holding member of a pendulum impact testing machine (impact testing apparatus).

### DESCRIPTION OF EMBODIMENT

The foamed sheet of the present invention has an average cell diameter of 10 to 200 μm, a resiliency of 6.0 N/cm² or less when compressed to 50% of an original thickness thereof, and a thickness recovery rate defined by the following equation of 90% or more. Hereinafter, the thickness recovery rate defined as above is sometimes simply referred to as the “thickness recovery rate after 0.5 seconds”.

Thickness recovery rate (%)=(thickness 0.5 seconds after compressed state is released)/(original thickness)×100

original thickness: a thickness of the foamed sheet before a load is applied,

thickness 0.5 seconds after compressed state is released: a thickness of the foamed sheet after a compressed state in which a load of 100 g/cm² is applied to the foamed sheet is kept for 120 seconds followed by release of the foamed sheet from the compression and an elapse of 0.5 seconds from the release.

The average cell diameter of the foamed sheet of the present invention is 10 to 200 μm as described above. The lower limit thereof is preferably 15 μm, more preferably 20 μm, and the upper limit thereof is preferably 180 μm, more preferably 150 μm, further preferably 100 μm. When the average cell diameter is 10 μm or more, excellent impact absorbability is highly exhibited. When the average cell diameter is 200 μm or less, the recoverability from compression is also excellent, and the foamed sheet can recover almost its original thickness in a short time after an impact is giving thereon, and thus has excellent resistance to repetitive impacts. The maximum cell diameter of the foamed sheet is, for example, 40 to 400 μm. The lower limit thereof is preferably 60 μm, more preferably 80 μm, and the upper limit thereof is preferably 300 μm, more preferably 220 μm. The minimum cell diameter of the foamed sheet is, for example, 5 to 70 μm. The lower limit thereof is preferably 8 μm, more preferably 10 μm, and the upper limit thereof is preferably 60 μm, more preferably 50 μm, further preferably 30 μm.

The resiliency of the foamed sheet of the present invention when compressed to 50% of an original thickness thereof is 6.0 N/cm² or less as described above, and is preferably 4.0 N/cm² or less, more preferably 2.9 N/cm² or less, further preferably 2.5 N/cm² or less. When the resiliency is 6.0 N/cm² or less, the foamed sheet of the present invention has highly excellent impact absorbability. The lower limit of the resiliency is preferably, but not particularly limited to, 0.1 N/cm². The resiliency when compressed to 50% of the original thickness can be measured according to the method for measuring the compressive hardness described in JIS K 6767.

The thickness recovery rate after 0.5 seconds of the foamed sheet of the present invention is 90% or more as described above, and is preferably 90.5% or more, more preferably 91% or more. When the thickness recovery rate is 90% or more, the foamed sheet can recover almost its original thickness in a short time after an impact is given thereon, and thus has excellent resistance to repetitive impacts, and the foamed sheet is also excellent in the dust resistance and the sealability. The thickness recovery rate after 0.5 seconds is a recovery rate determined when a load is applied to a certain area of the foamed sheet to compress, and it is different from a so-called depression recovery, which is determined when a load is locally applied to depress only a part.

The thickness of the foamed sheet of the present invention is preferably, but not limited to, 30 to 1000 μm. The lower limit thereof is preferably 40 μm, more preferably 50 μm, and the upper limit thereof is preferably 700 μm, more preferably 500 μm, further preferably 300 μm. When the thickness of the foamed sheet is 30 μm or more, the foamed sheet can include air cells uniformly to exhibit highly excellent impact absorbability. When the thickness of the foamed sheet is 1000 μm or less, the foamed sheet can readily fit against a very small clearance. When the thickness of the foamed sheet is within the above described range, the foamed sheet has excellent impact absorbability notwithstanding its small thickness.

The density of the foamed sheet of the present invention is preferably, but not limited to, 0.2 to 0.7 g/cm³. The lower limit thereof is preferably 0.21 g/cm³, more preferably 0.22 g/cm³, and the upper limit thereof is preferably 0.50 g/cm³, more preferably 0.40 g/cm³, further preferably 0.35 g/cm³. When the density is 0.2 g/cm³ or more, the strength of the foamed sheet tends to be secured. When the density is 0.7 g/cm³ or less, higher impact absorbability is exhibited. When the density is within the range from 0.2 to 0.7 g/cm³, even higher impact absorbability is exhibited. The density of the foamed sheet (foam) herein means an “apparent density”.

In the present invention, the ratio of the average cell diameter (μm) to the thickness (μm) of the foamed sheet (the former/the latter) is preferably within the range from 0.1 to 0.8 in view of impact absorbability. The lower limit of the ratio of the average cell diameter (μm) to the thickness (μm) of the foamed sheet is preferably 0.15, more preferably 0.2, and the upper limit thereof is preferably 0.75, more preferably 0.6.

The peak top of the loss tangent (tan δ) of the foamed sheet of the present invention appears preferably, but not limited to, within a range not less than −60° C. and not more than 20° C., wherein the tan δ is a ratio of a loss modulus to a storage modulus at an angular frequency of 1 rad/s in a dynamic viscoelasticity measurement. The lower limit of the temperature range within which the peak top of the loss tangent appears is preferably −50° C., more preferably −40° C., further preferably −30° C., and the upper limit thereof is preferably 10° C., more preferably 0° C., further preferably −10° C., particularly preferably −15° C. (for example, −20° C.). It is desirable that when two or more peak tops of the loss tangent of a material appears, at least one of them be within the above described range. When the peak top appears within the above described range, the foamed sheet has less temperature dependency to exhibit highly excellent recoverability from compression even in a high temperature environment, and also has high flexibility to exhibit excellent impact absorbability. When the peak top is high, the flexibility tends to decrease, and when the peak top is low, the recoverability from compression tends to decrease. Particularly, the temperature at which the peak top of the loss tangent (tan δ) appears is within a range from −50 to −10° C., especially −30 to −15° C., the various properties of the foamed sheet, including the resiliency when compressed to 50% of the original thickness, the thickness recovery rate after 0.5 seconds, and the thickness recovery rate at a high temperature described later, can be more readily adjusted within the respective range described herein.

In view of impact absorbability, the intensity (the maximum value) at the peak top of the loss tangent (tan δ) within a range not less than −60° C. and not more than 20° C. is preferably high, for example, 0.2 or more, more preferably 0.3 or more. The upper limit of the intensity at the peak top (the maximum value) is 2.0, for example.

The foamed sheet of the present invention preferably has a ratio of the intensity at the peak top of the loss tangent (tan δ) to the density (the former/the latter) within a range of 1 to 5. The lower limit of the ratio of the intensity at the peak top of the loss tangent (tan δ) to the density is preferably 1.5, more preferably 2, and the upper limit thereof is preferably 4.5, more preferably 4, further preferably 3. When the ratio of the intensity at the peak top of the loss tangent (tan δ) to the density is within the range described above, highly excellent impact absorbability is exhibited.

In view of impact absorbability, the foamed sheet of the present invention desirably has a lower initial modulus. The initial modulus (the value calculated from the slope at 10% strain in a tensile test in an environment at 23° C. at a tension rate of 300 mm/min using a sample having an initial size of 10 mm wide×40 mm length) is preferably 5 N/mm² or less, more preferably 3 N/mm² or less, further preferably 1 N/mm² or less. The lower limit of the initial modulus is 0.1 N/mm², for example.

In view of impact absorbability, the foamed sheet of the present invention desirably has a lower initial modulus. The initial modulus (the value calculated from the slope at 10% strain in a tensile test in an environment at 0° C. at a tension rate of 300 mm/min using a sample having an initial size of 10 mm wide×40 mm length) is preferably 5 N/mm² or less, more preferably 3 N/mm² or less, further preferably 1 N/mm² or less. The lower limit of the initial modulus is 0.1 N/mm², for example. When the initial modulus in an environment at 0° C. is high, there is a tendency that the flexibility is likely to decrease, and when the initial modulus in an environment at 0° C. is low, there is a tendency that the recoverability from compression decreases.

For the foamed sheet of the present invention, the composition, the cellular structure, and so on are not particularly limited as long as the foamed sheet has the properties described above. The cellular structure is any of a continuous cellular structure, a closed cellular structure, and a semi-continuous and semi-closed cellular structure. The continuous cellular structure or a semi-continuous and semi-closed cellular structure is preferable in view of impact absorbability.

The foamed sheet of the present invention has excellent impact absorbability. The foamed sheet of the present invention has high impact absorbability even with respect to a very small impact, and thus exhibits excellent impact absorbability irrespective of the magnitude of the impact. For example, in an impact absorption test using a pendulum impact testing machine, the impact absorption rate (%) defined by the following equation is divided by the thickness (μm) of the foamed sheet to obtain an impact absorption rate R per unit thickness:

impact absorption rate (%)={(F₀−F₁)/F₀}×100

wherein F₀ represents the impulsive force when an impacting object is allowed to collide against a single substrate, and F₁ represents the impulsive force when an impacting object is allowed to collide against a substrate of a structure composed of the substrate and the foamed sheet.

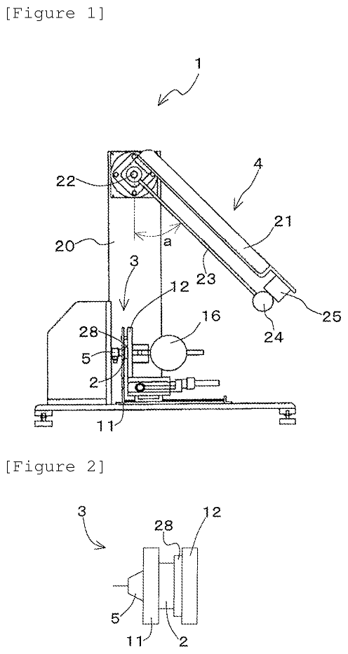

The outline of the configuration of the pendulum impact testing machine (impact testing apparatus) will be described with reference to FIGS. 1 and 2. As shown in FIGS. 1 and 2, the impact testing apparatus 1 (pendulum testing machine 1) is composed of a holding member 3 as a holding means for holding a specimen 2 (foamed sheet 2) at an arbitral holding force, an impact loading member 4 for giving an impact stress to the specimen 2, a pressure sensor 5 as an impulsive force-detecting means for detecting the impulsive force of the impact loading member 4 on the specimen 2, and so on. The holding member 3 for holding the specimen 2 at an arbitral holding force is composed of a fixing jig 11 and a Holding jig 12 that is slidable so as to face to the fixing jig 11 to interpose the specimen 2 therebetween and hold it. The Holding jig 12 is provided with a holding pressure adjustment means 16. The impact loading member 4, which gives an impulsive force to the specimen 2 held by the holding member 3, is composed of a supporting bar 23 (shaft 23) that is pivotally attached to a pillar 20 at an end 22 thereof and has an impacting object 24 at the other end, and an arm 21 that lifts up and holds the impacting object 24 at a specific angle. A steel ball is used here as the impacting object 24, and therefore, an electromagnet 25 provided at the end of the arm can lift up the impacting object 24 together therewith at the specific angle. The pressure sensor 5 for detecting the impulsive force of the impulsive impact loading member 4 on the specimen 2 is provided on the side of the fixing jig 11 opposite to the side that is brought into contact with the specimen.

The impacting object 24 is a steel ball (iron ball). The angle (swing angle a in FIG. 1) at which the impacting object 24 is lifted up by the arm 21 is 40°. The weight of the steel ball (iron ball) is 66 g.

As shown in FIG. 2, the specimen 2 (foamed sheet 2) is sandwiched with a plate having high elasticity, such as a resin plate (an acryl plate, a polycarbonate plate, or the like) or a metal plate, as a substrate 28 between the fixing jig 11 and the Holding jig 12.

With the impact testing apparatus, determined are an impulsive force F₀ that is measured when adhering closely and fixing the substrate 28 to the fixing jig 11 and then allowing the impacting object 24 to collide against the substrate 28, and an impulsive force F₁ that is measured when inserting the specimen 2 between the substrate 28 and the fixing jig 11 to adhere closely and fix the specimen 2 to them and then allowing the impacting object 24 to collide against the substrate 28, and the impact absorption rate is calculated therefrom by the equation described above. The impact testing apparatus is the same as described in Example 1 in JP 2006-47277A.

F₁ in the conditions of a weight of the impacting object of 66 g and an amplitude of 40°, in other words, an impulsive force when an impacting object is allowed to collide against a substrate of a structure composed of the substrate and a foamed sheet in an impact absorption test using a pendulum impact testing machine is preferably 1000 N or less, more preferably 900 N or less, further preferably 800 N or less, particularly preferably 750 N or less. When the impulsive force is 1000 N or less, the foamed sheet has highly excellent impact absorbability. The lower limit of the impulsive force is 0 N or more, and may be 100 N or more, 300 N or more, or 500 N or more. The impulsive force is an impulsive force on an original foamed sheet that has not been given any large impact.

In a plot including five points with the order of the impact as the x-axis and the impulsive force (N) as the y-axis when an impacting object is allowed to collide five times continuously at one-second intervals against a substrate of a structure composed of the substrate and the foamed sheet in an impact absorption test using a pendulum impact testing machine, the slope of the linear approximation line obtained from the five points according to the least-squares method is preferably, but not limited to, 10 or less, more preferably 5 or less, further preferably 1 or less, particularly preferably 0.5 or less. When the slope is 10 or less, the resistance to repetitive impacts is highly excellent. The lower limit of the slope is, for example, −5.

When an impacting object is allowed to collide five times continuously at one-second intervals against a substrate of a structure composed of the substrate and the foamed sheet in an impact absorption test using a pendulum impact testing machine, an increment (%) of an impulsive force at a fifth collision from an impulsive force at a first collision [((the impulsive force at the fifth collision)−(the impulsive force at the first collision))/(the impulsive force at the first collision)×100] is preferably 5% or less, more preferably 3.5% or less, further preferably 2% or less. When the increment is 5% or less, the resistance to repetitive impacts is highly excellent. The lower limit of the increment is, for example, −10%.

In the foamed sheet according to the present invention, a thickness recovery rate at a high temperature defined below is preferably 50% or more, more preferably 70% or more, still more preferably 80% or more, still more preferably 90% or more, and especially preferably 94% or more. In the present specification, the thickness recovery rate at a high temperature defined below may be simply referred to as “a thickness recovery rate at a high temperature.”

Thickness recovery rate at a high temperature: a ratio of a thickness 24 hours after releasing a compressed state at a high temperature to an original thickness, wherein the foamed sheet is compressed in an atmosphere at 80° C. in a thickness direction to 50% of the original thickness thereof and left for 22 hours, then left standing in an atmosphere at 23° C. for 2 hours, and then released from compression.

When the foamed sheet according to the present invention has a thickness recovery rate at a high temperature of 50% or more, even under high temperature environment (for example, under a temperature environment of 40 to 120° C.) in addition to room temperature environment, a recovery speed of thickness after impact is high, and resistance to repetitive impact under high temperature environment is more excellent.

The foamed sheet of the present invention may be composed of a resin composition containing a resin material (polymer). It is preferable that a peak top of a loss tangent (tan δ) of the resin composition in an unfoamed state [the resin composition (solid matter) which is not foamed] appears within a range not less than −60° C. and not more than 20° C., in which the tan δ is a ratio of a loss modulus to a storage modulus at an angular frequency of 1 rad/s in a dynamic viscoelasticity measurement. The lower limit of temperature range within which the peak top of the above-mentioned loss tangent appears is preferably −50° C., more preferably −40° C., and still more preferably −30° C. Meanwhile, the upper limit is preferably 10° C., more preferably 0° C., still more preferably −10° C., and especially preferably −15° C. (for example, −20° C.). When the material has two or more peak tops of the loss tangent, it is desirable at least one of them appear within the above-mentioned ranges. A the intensity at the peak top of the loss tangent (tan δ) of the resin composition (solid matter) within the range of not less than −60° C. and not more than 20° C. (this strength corresponds to a value of the intensity at the peak top of the loss tangent (tan δ) of the above-mentioned foamed sheet within the range of not less than −60° C. and not more than 20° C. divided by a density (g/cm³) of the foamed sheet) is preferably high from a viewpoint of impact absorption. For example, the intensity at the peak top of the loss tangent (tan δ) of the resin composition (solid matter) within the range of not less than −60° C. and not more than 20° C. is preferably 0.9 (g/cm³)⁻¹ or more, and the upper limit is, for example, approximately 3.

Moreover, an original modulus (23° C., original sample size 10 mm width×40 mm length, tension rate 300 mm/min) of the resin composition in an unfoamed state (solid matter) is desirably low. The original modulus is preferably 50 N/mm² or less and more preferably 30 N/mm² or less. The lower limit of the original modulus is, for example, 0.3 N/mm².

Moreover, an original modulus (0° C., original sample size 10 mm width×40 mm length, tension rate 300 mm/min) of the resin composition in an unfoamed state (solid matter) is desirably low. The original modulus is preferably 50 N/mm² or less and more preferably 30 N/mm² or less. The lower limit of the original modulus is, for example, 0.3 N/mm². When the original modulus at 0° C. is high, there is a tendency that flexibility is easily degraded. When the original modulus at 0° C. is low, there is a tendency that compression recovery is degraded.

A content insoluble (gel molar fraction) of the foamed sheet according to the present invention to methyl ethyl ketone as a solvent is not particularly limited but preferably 80% or more by weight and more preferably 90% by weight. The content insoluble to methyl ethyl ketone as a solvent is usually 100% or less by weight.

The content insoluble (gel molar fraction) to methyl ethyl ketone is determined as follows. Approximately 0.2 g of sample is obtained from the foamed sheet, and this sample is precisely weighed to define a weight obtained by the precise weighing as “weight before storage (g).” Next, this sample is put into 50 g of methyl ethyl ketone (MEK) and stored for five days under a room temperature condition. Thereafter, the sample is taken out from methyl ethyl ketone, and the taken-out sample is dried at 130° C. for 1 hour. After the drying, the sample is left for 30 minutes under a room temperature condition and then precisely weighed. A weight obtained by the precise weighing is defined as “weight after storage (g).” Then, a content insoluble to methyl ethyl ketone is calculated using the following formula.

Content insoluble to methyl ethyl ketone (% by weight)=(Weight after storage)/(Weight before storage)×100

A resin material (polymer) constituting the foamed sheet according to the present invention is not particularly limited, but known or well-known resin materials constituting foams can be used. The resin material includes, for example, an acrylic polymer, a rubber, a urethane polymer and an ethylene-vinyl acetate copolymer, etc. Among these, an acrylic polymer is preferable because: its permanent strain is small; its thermal resistance (resistance to deformation and strain) is excellent; a compressive load can be easily decreased; and its impact absorption is excellent. The resin material (polymer) constituting the foamed sheet may be one kind or two or more kinds.

Tg of the resin material (polymer) can be used as an indicator or a standard in order to set a peak top of the loss tangent (tan δ) within a range not less than −60° C. and not more than 20° C., in which the tan δ is a ratio of a loss modulus to a storage modulus at an angular frequency of 1 rad/s in a dynamic viscoelasticity measurement. For example, the resin material (polymer) can be selected from materials whose Tg is within the range not less than −60° C. and not more than 20° C. (the lower limit is preferably −50° C. and more preferably −30° C. while the upper limit is preferably 10° C., more preferably 0° C., still more preferably −10° C., and especially preferably −15° C. (for example, −20° C.)).

The intensity at the peak top of the loss tangent (tan δ) is preferably 0.8 or more, more preferably 1 or more, still more preferably 1.5 or more, and especially preferably 1.7 or more, in which the tan δ is a ratio of a loss modulus to a storage modulus at an angular frequency of 1 rad/s in a dynamic viscoelasticity measurement. When the intensity at the peak top is larger, impact absorption becomes more excellent.

The acrylic polymer is preferably one formed of, as essential monomer components, a monomer having a Tg of its homopolymer of not less than −10° C. and a monomer having a Tg of its homopolymer of less than −10° C. By using such an acrylic polymer and adjusting the amount ratio of the former and latter monomers, the foamed sheet can be relatively easily obtained, wherein a peak top of a loss tangent (tan δ) thereof appears within a range not less than −60° C. and not more than 20° C., wherein the tan δ is a ratio of a loss modulus to a storage modulus at an angular frequency of 1 rad/s in a dynamic viscoelasticity measurement.

A “glass transition temperature (Tg) when a homopolymer is formed” (simply referred to as “Tg of a homopolymer” in some cases) in the present invention means a “glass transition temperature (Tg) of a homopolymer of the corresponding monomer”; and numerical values are specifically cited in “Polymer Handbook” (3rd edition, John Wiley & Sons, Inc., 1987). Tgs of homopolymers of monomers which are not described in the above literature are values obtained, for example, by the following measurement method (see Japanese Patent Laid-Open No. 2007-51271). That is, 100 parts by weight of a monomer, 0.2 parts by weight of 2,2′-azobisisobutyronitrile, and 200 parts by weight of ethyl acetate as a polymerization solvent are charged in a reaction vessel equipped with a thermometer, a stirrer, a nitrogen introducing tube and a refluxing cooling tube, and stirred for 1 hour under the introduction of nitrogen gas. After oxygen in the polymerization system is removed in such a way, the system is heated up to 63° C. and allowed to react for 10 hours. Then, the system is cooled to room temperature to obtain a homopolymer solution having a solid content concentration of 33% by weight. Then, the homopolymer solution is cast and applied on a separator, and dried to fabricate a test sample (sheet-like homopolymer) having a thickness of about 2 mm. The test sample is punched out into a disc of 7.9 mm in diameter, and interposed between parallel plates; and the viscoelasticity is measured by using a viscoelasticity tester (ARES, manufactured by Rheometric Scientific, Inc.) in a temperature region of −70 to 150° C. at a temperature-rise rate of 5° C./min in a shearing mode under a shearing strain of 1 Hz in frequency, and the peak top temperature in tan δ is defined as Tg of the homopolymer. Also Tg of the resin material (polymer) can be measured by this method.

In a monomer having a Tg of its homopolymer of not less than −10° C., the Tg is, for example, −10° C. to 250° C., preferably 10 to 230° C., more preferably 50 to 200° C., and particularly preferably 100 to 200° C.,

Examples of the monomer having a Tg of its homopolymer of not less than −10° C. include (meth)acrylonitrile; amide group-containing monomers such as (meth)acrylamide and N-hydroxyethyl(meth)acrylamide; carboxyl group-containing (meth)acrylic monomer having a Tg of their homopolymer of not less than −10° C. such as (meth)acrylic acid; alkyl (meth)acrylates having a Tg of their homopolymer of not less than −10° C., such as methyl methacrylate and ethyl methacrylate; alicyclic (meth)acrylates having a Tg of their homopolymer of not less than −10° C. such as isobornyl (meth)acrylate and cyclohexyl (meth)acrylate; aromatic (meth)acrylates having a Tg of their homopolymer of not less than −10° C. such as benzyl (meth)acrylate; heterocycle-containing vinyl monomers such as N-vinyl-2-pyrrolidone and acryloylmorpholine; and hydroxyl group-containing monomers such as 2-hydroxyethyl methacrylate. These can be used singly or in combinations of not less than two. Among these, monomers having a functional group such as a carboxyl group, a hydroxyl group, or a nitrogen atom-containing group (such as a nitrile group) (particularly, (meth)acrylonitrile, (meth)acrylic acid, and 2-hydroxyethyl (meth)acrylate) are preferable. Acrylonitrile and acrylic acid are particularly preferable. In the case where a monomer having a Tg of its homopolymer of not less than −10° C. is used, probably because of the strong intermolecular interaction, the intensity of the peak top of the loss tangent (tan δ) of the foamed sheet can be made high.

In the monomer having a Tg of its homopolymer of less than −10° C., the Tg is, for example, not less than −70° C. and less than −10° C., preferably −70° C. to −12° C., and more preferably −65° C. to −15° C.

Examples of the monomer having a Tg of its homopolymer of less than −10° C. include alkyl (meth)acrylates having a Tg of their homopolymer of less than −10° C., such as ethyl acrylate, butyl acrylate and 2-ethylhexyl acrylate. These can be used singly or in combinations of not less than two. Among these, C₂₋₈ alkyl acrylates are preferable, and C₄₋₈ alkyl acrylates are particularly preferable.

The content of a monomer having a Tg of its homopolymer of not less than −10° C. with respect to the whole monomer components (total amount of monomer components) forming the acrylic polymer is, for example, 2 to 30% by weight, and the lower limit is preferably 3% by weight, and more preferably 4% by weight; and the upper limit is preferably 25% by weight, and more preferably 20% by weight. The content of a monomer having a Tg of its homopolymer of less than −10° C. with respect to the whole monomer components (total amount of monomer components) forming the acrylic polymer is, for example, 70 to 98% by weight, and the lower limit is preferably 75% by weight, and more preferably 80% by weight; and the upper limit is preferably 97% by weight, and more preferably 96% by weight.

The acrylic polymer particularly preferably contains not less than 50% by weight (preferably not less than 70%, and more preferably not less than 80%) of alkyl (meth)acrylate having a straight-chain or branched-chain alkyl group having carbon atoms of 4 to 8 with respect to the whole monomer components as a monomer component forming the acrylic polymer, and 2 to 20% by weight (preferably 3 to 15% by weight, and more preferably 5 to 10% by weight) of a monomer having a Tg of its homopolymer of not less than 10° C. and having a functional group such as a carboxyl group, a hydroxyl group, or a nitrogen atom-containing group (such as a nitrile group).

The rubber may be either of natural rubber and synthetic rubber. Examples of the rubber include nitrile rubber (NBR), methyl methacrylate-butadiene rubber (MBR), styrene-butadiene rubber (SBR), acrylic rubber (ACM, ANM), urethane rubber (AU) and silicone rubber. Among these, preferable are nitrile rubber (NBR), methyl methacrylate-butadiene rubber (MBR) and silicone rubber.

Examples of the urethane polymer include polycarbonate-based polyurethane, polyester-based polyurethane and polyether-based polyurethane.

As the ethylene-vinyl acetate copolymer, publicly or commonly known ethylene-vinyl acetate copolymers can be used.

The foamed sheet of the present invention, in addition to the resin material (polymer), may contain, as required, a surfactant, a crosslinking agent, a thickener, a rust preventive, a silicone-based compound, and other additives. Among these, from the viewpoint that the foamed sheet can be easily obtained, which has a resiliency of 6.0 N/cm² or less when compressed to 50% of an original thickness thereof, and a thickness recovery rate of 90% or more after 0.5 seconds, the foamed sheet preferably contains a crosslinking agent and a silicone-based compound. Furthermore, various characteristics of the foamed sheet such as the thickness recovery rate at high temperatures are more likely to be designed within ranges described herein.

For example, for the micronization of the cell diameter and the stabilization of cells foamed, an optional surfactant may be contained. The surfactant is not particularly limited, and there may be used any of an anionic surfactant, a cationic surfactant, a nonionic surfactant, an amphoteric surfactant and the like; but from the viewpoint of the micronization of the cell diameter and the stabilization of cells foamed, an anionic surfactant is preferable, and a fatty acid ammonium-based surfactant such as particularly ammonium stearate and the like is more preferable. The surfactants may be used singly or in combinations of not less than two. Dissimilar surfactants may be used concurrently, and for example, an anionic surfactant and a nonionic surfactant, or an anionic surfactant and an amphoteric surfactant may be used concurrently.

In the case where the surfactant is contained, the amount [solid content (nonvolatile content)] of the surfactant to be added is, with respect to 100 parts by weight of the resin material (polymer) [solid content (nonvolatile content)], for example, more than 0 part by weight and not more than 10 parts by weight, and the lower limit is preferably 0.5 parts by weight; and the upper limit is preferably 8 parts by weight.

In order to easily obtain the foamed sheet which has a resiliency of 6.0 N/cm² or less when compressed to 50% of an original thickness thereof, and a thickness recovery rate of 90% or more after 0.5 seconds, to be likely to set various characteristics of the foamed sheet such as the thickness recovery rate at high temperatures within ranges described herein, and to improve the strength, heat resistance and moisture resistance of the foamed sheet, the foamed sheet of the present invention may contain an optional crosslinking agent. The crosslinking agent is not particularly limited, and either of an oil-soluble one and a water-soluble one may be used. Examples of the crosslinking agent include epoxy-based, oxazoline-based, isocyanate-based, carbodiimide-based, melamine-based, silicone-based (for example, a silane coupling agent and the like), and metal oxide-based ones. The crosslinking agents may be used singly or in combinations of not less than two. Among these, at least oxazoline-based crosslinking agents are preferably contained.

In the case where the crosslinking agent is contained, the amount [solid content (nonvolatile content)] of the crosslinking agent to be added is, with respect to 100 parts by weight of the resin material (polymer) [solid content (nonvolatile content)], for example, more than 0 part by weight and not more than 10 parts by weight, and the lower limit is preferably 0.01 parts by weight; and the upper limit is preferably 9 parts by weight.

Furthermore, for the stabilization of cells foamed and the improvement of the film formability, an optional thickener may be contained. The thickener is not particularly limited, and includes acrylic acid-based, urethanic and polyvinyl alcoholic ones. Among these, polyacrylic acid-based thickeners and urethanic thickeners are preferable.

In the case where the thickener is contained, the amount [solid content (nonvolatile content)] of the thickener to be added is, with respect to 100 parts by weight of the resin material (polymer) [solid content (nonvolatile content)], for example, more than 0 part by weight and not more than 10 parts by weight, and the lower limit is preferably 0.1 parts by weight; and the upper limit is preferably 5 parts by weight.

In order to prevent the corrosion of metal members adjacent to the foamed sheet, an optional rust preventive may be contained. The rust preventive is preferably an azole ring-containing compound. In the case where an azole ring-containing compound is used, both the corrosion prevention of metals and the close adhesion with objects can be met simultaneously in high levels.

The azole ring-containing compound suffices as long as being a compound having 5-membered ring containing not less than one nitrogen atom in the ring, and examples include compounds having a diazole (imidazole, pyrazole) ring, a triazole ring, a tetrazole ring, an oxazole ring, an isoxazole ring, a triazole ring or an isothiazole ring. These rings may be condensed with an aromatic ring such as a benzene ring to form condensed rings. Examples of compounds having such a condensed ring include compounds having a benzimidazole ring, a benzopyrazole ring, a benzotriazol ring, a benzoxazole ring, a benzisoxazole ring, a benzothiazole ring or a benzisothiazole ring.

The azole ring and the condensed rings (benzotriazole ring, benzothiazole ring and the like) may each have a substituent. Examples of the substituent include alkyl groups having 1 to 6 carbon atoms (preferably having 1 to 3 carbon atoms) such as a methyl group, an ethyl group, a propyl group, an isopropyl group and a butyl group; alkoxy groups having 1 to 12 carbon atoms (preferably having 1 to 3 carbon atoms) such as a methoxy group, an ethoxy group, an isopropyloxy group and a butoxy group; aryl groups having 6 to 10 carbon atoms such as a phenyl group, a tolyl group and a naphthyl group; an amino group; (mono- or di-) C₁₋₁₀ alkylamino groups such as a methylamino group and a dimethylamino group; amino-C₁₋₆ alkyl groups such as an aminomethyl group and 2-aminoethyl group; mono- or di-(C₁₋₁₀ alkyl)amino-C₁₋₆ alkyl groups such as an N,N-diethylaminomethyl group and an N,N-bis(2-ethylhexyl)aminomethyl group; a mercapto group; alkoxycarbonyl groups having 1 to 6 carbon atoms such as a methoxycarbonyl group and an ethoxycarbonyl group; a carboxyl group; carboxy-C₁₋₆ alkyl groups such as a carboxymethyl group; carboxy-C₁₋₆ alkylthio groups such as 2-carboxyethylthio group; N,N-bis(hydroxy-C₁₋₄ alkyl)amino-C₁₋₄ alkyl groups such as an N,N-bis(hydroxymethyl)aminomethyl group; and a sulfo group. The azole ring-containing compound may form a salt such as a sodium salt or a potassium salt.

From the viewpoint of the rust preventive action on metals, preferable are compounds in which an azole ring forms a condensed ring with an aromatic ring such as a benzene ring; and among these, particularly preferable are benzotriazole-based compounds (compounds having a benzotriazole ring) and benzothiazole-based compounds (compounds having a benzothiazole ring).

Examples of the benzotriazole-based compounds include 1,2,3-benzotriazole, methylbenzotriazole, carboxybenzotriazole, carboxymethylbenzotriazole, 1-[N,N-bis(2-ethylhexyl)aminomethyl]benzotriazole, 1-[N,N-bis(2-ethylhexyl)aminomethyl]methylbenzotriazole, 2,2′-[[(methyl-1H-benzotriazol-1-yl)methyl]imino]bisethanol, and sodium salts thereof.

Examples of the benzothiazole-based compounds include 2-mercaptobenzothiazole, 3-(2-(benzothiazolyl)thio)propionic acid, and sodium salts thereof.

The azole ring-containing compounds may be used singly or in combinations of not less than two.

In the case where the rust preventive is contained, the amount [solid content (nonvolatile content)] of the rust preventive (for example, the azole ring-containing compound) [solid content (nonvolatile content)] to be added suffices as long as being in the range of not impairing the intrinsic property of a foam, and is, for example, with respect to 100 parts by weight of the resin material (polymer) [solid content (nonvolatile content)], for example, preferably 0.2 to 5 parts by weight. The lower limit thereof is more preferably 0.3 parts by weight, and still more preferably 0.4 parts by weight; and the upper limit thereof is more preferably 3 parts by weight, and still more preferably 2 parts by weight.

In order to improve the recovery and the recovery speed of the thickness of the foamed sheet after being compressed (particularly, in order to set the thickness recovery rate after 0.5 seconds to not less than 90%), and to be likely to set various characteristics of the foamed sheet such as the thickness recovery rate at high temperatures within ranges described herein, a silicone-based compound is preferably added. For the same purpose, a silicone-modified polymer (for example, a silicone-modified acrylic polymer, a silicone-modified urethane polymer and the like) may be used as at least a part of the resin material (polymer). These may be used singly or in combinations of not less than two.

The silicone-based compound preferably has not more than 2,000 siloxane bonds. Examples of the silicone-based compound include silicone oils, modified silicone oils and silicone resins.

Examples of the silicone oils (straight silicone oils) include dimethyl silicone oils and methyl phenyl silicone oils.

Examples of the modified silicone oils include polyether-modified silicone oils (polyether-modified dimethyl silicone oils and the like), alkyl-modified silicone oils (alkyl-modified dimethyl silicone oils and the like), aralkyl-modified silicone oils (aralkyl-modified dimethyl silicone oils and the like), higher fatty acid ester-modified silicone oils (higher fatty acid ester-modified dimethyl silicone oils and the like) and fluoroalkyl-modified silicone oils (fluoroalkyl-modified dimethyl silicone oils and the like).

Among these, polyether-modified silicones are preferable. Examples of commercially available products of the polyether-modified silicone oils include straight chain-type ones such as “PEG 11 Methyl Ether Dimethicone”, “PEG/PPG-20/22 Butyl Ether Dimethicone”, “PEG-9 Methyl Ether Dimethicone”, “PEG-32 Methyl Ether Dimethicone”, “PEG-9 Dimethicone”, “PEG-3 Dimethicone” and “PEG-10 Dimethicone”; and branched chain-type ones such as “PEG-9 Polydimethylsiloxyethyl Dimethicone” and “Lauryl PEG-9 Polydimethylsiloxyethyl Dimethicone” (which are all manufactured by Shin-Etsu Chemical Co., Ltd.).

The silicone resins include straight silicone resins and modified silicone resins. Examples of the straight silicone resins include methyl silicone resins and methyl phenyl silicone resins. Examples of the modified silicone resins include alkyd-modified silicone resins, epoxy-modified silicone resins, acryl-modified silicone resins and polyester-modified silicone resins.

The total content of the silicone-based compound and the silicone chain moiety present in the silicone-modified polymer, in the foamed sheet of the present invention is, with respect to 100 parts by weight of the resin material (polymer) in the foamed sheet of the present invention, for example, 0.01 to 5 parts by weight in terms of nonvolatile content (in terms of solid content). The lower limit of the total content is preferably 0.05 parts by weight, and more preferably 0.1 parts by weight; and the upper limit is preferably 4 parts by weight, and more preferably 3 parts by weight. In the case where the total content of the silicone component and the silicone chain moiety in the foamed sheet of the present invention is in the above range, the recovery and the recovery speed after compression are likely to be improved without impairing the properties as a foamed sheet.

The total content of the silicone-based compound and the silicone chain moiety present in the silicone-modified polymer in the foamed sheet of the present invention is, for example, 0.01 to 5 parts by weight in terms of nonvolatile content (in terms of solid content). The lower limit of the total content is preferably 0.05 parts by weight, and more preferably 0.1 parts by weight; and the upper limit is preferably 4 parts by weight, and more preferably 3 parts by weight. In the case where the total content of the silicone component and the silicone chain moiety in the foamed sheet of the present invention is in the above range, the recovery and the recovery speed after compression are likely to be improved without impairing the properties as a foamed sheet.

Optional other suitable components may be contained in the range of not impairing the impact absorption. Such other components may be contained in one kind thereof alone, or may be contained in not less than two kinds thereof. Examples of the other components include polymer components other than the above, softening agents, antioxidants, antiaging agents, gelling agents, curing agents, plasticizers, fillers, reinforcing agents, foaming agents, flame retardants, light stabilizers, ultraviolet absorbents, coloring agents (pigments, dyes and the like), pH regulators, solvents (organic solvents), thermopolymerization initiators and photopolymerization initiators.

Examples of the fillers include silica, clay (mica, talc, smectite and the like), alumina, titania, zinc oxide, tin oxide, zeolite, calcium carbonate, graphite, carbon nanotubes, inorganic fibers (carbon fibers, glass fibers, and the like), organic fibers, and metal powders (silver, copper, and the like). As the filler, there can also be added piezoelectric particles (titanium oxide and the like), electroconductive particles, thermoconductive particles (boron nitride and the like), organic fillers (silicone powder, and the like) and the like.

Among these, the filler is preferably silica or calcium carbonate. In the case where silica or calcium carbonate is used as the filler, the thickness recovery rate at high temperatures can be further improved. The recovery and the recovery speed after being compressed are likely to be further improved.

In the case where the foamed sheet of the present invention contains the filler, the content of the filler is preferably 0.5 to 10 parts by weight based on 100 parts by weight of the resin material (polymer) in the foamed sheet of the present invention, more preferably 0.8 to 6 parts by weight, and still more preferably 0.9 to 5 parts by weight. In the case where the content is not less than 0.5 parts by weight, the thickness recovery rate at high temperatures can be further improved. The recovery and the recovery speed after being compressed are likely to be further improved. In the case where the content is not more than 10 parts by weight, the thickness recovery rate at high temperatures, and the recovery and the recovery speed after being compressed are likely to be further improved without deteriorating the flexibility of the foamed sheet.

The foamed sheet of the present invention can be produced by subjecting a resin composition containing the constituting resin material (polymer) to foam molding. As a foaming method (method of forming cells), there can be employed methods usually used for foam molding, including physical methods and chemical methods. That is, the foamed sheet of the present invention may be a foam (physically foamed product) foamed by physical methods, or may be a foam (chemically foamed product) foamed by chemical methods. The physical methods generally involve dispersing a gas component such as air or nitrogen in a polymer solution, and forming bubbles by mechanical mixing (mechanically foamed product). The chemical methods are ones in which cells are formed by a gas generated by thermal decomposition of a foaming agent added to a polymer base, to obtain foams. From the viewpoint of environmental problems and the like, the physical methods are preferable. Cells to be formed by the physical methods are open cells in many cases.

As the resin composition containing the resin material (polymer) to be subjected to foam molding, there may be used a resin solution in which the resin material is dissolved in a solvent, but from the viewpoint of the foamability, an emulsion containing the resin material is preferably used. That is, the foamed sheet of the present invention is preferably a foamed product made of an emulsion resin composition. Not less than two emulsions may be blended and used as the emulsion. The resin composition may be stored as a resin composition containing no crosslinking agent, a crosslinking agent being mixed therewith immediately before being subjected to expansion molding.

It is preferable from the viewpoint of the film formability that the solid content concentration of the emulsion is higher. The solid content concentration of the emulsion is preferably not less than 30% by weight, more preferably not less than 40% by weight, and still more preferably not less than 50% by weight.

In the present invention, a method is preferable in which a foamed product is fabricated through a step (step A) of mechanically foaming an emulsion resin composition to foam the emulsion resin composition. That is, the foamed sheet of the present invention is preferably a mechanically foamed product made of an emulsion resin composition. A foaming apparatus is not particularly limited, and examples thereof include apparatuses such as a high-speed shearing system, a vibration system, and a discharge system of a pressurized gas. Among these, from the viewpoint of the micronization of the cell diameter and the fabrication of a large volume, a high-speed shearing system is preferable.

Bubbles foamed by mechanical stirring are ones of gas entrapped in the emulsion. The gas is not particularly limited as long as being inactive to the emulsion, and includes air, nitrogen and carbon dioxide. Among these, from the viewpoint of the economical efficiency, air is preferable.

By subjecting the emulsion resin composition foamed by the above method to a step (step B) of coating a base material with the emulsion resin composition followed by drying, the foamed sheet according to the present invention can be obtained. The base material is not particularly limited, but examples thereof include release-treated plastic films (release-treated polyethylene terephthalate films and the like), plastic films (polyethylene terephthalate films and the like) and thermoconductive layers (thermoconductive layers described later). In the case of coating by using a thermoconductive layer as the base material, the close adhesion of the foamed sheet with the thermoconductive layer can be improved and the efficiency of a drying step in the fabrication of the foamed sheet can also be improved.

As a coating method and a drying method in step B, usual methods can be employed. It is preferable that step B includes preliminary drying step B1 of drying the bubble-containing emulsion resin composition applied on the base material at not less than 50° C. and less than 125° C., and regular drying step B2 of thereafter further drying the resultant at not less than 125° C. and not more than 200° C.

By providing preliminary drying step B1 and regular drying step B2, the coalescence of bubbles and the burst of bubbles due to a rapid temperature rise can be prevented. Particularly in the foamed sheet having a small thickness, since bubbles coalesce or burst in a rapid rise of the temperature, the significance of the provision of preliminary drying step B1 is large. The temperature in preliminary drying step B1 is preferably not less than 50° C. and not more than 100° C. The time of preliminary drying step B1 is, for example, 0.5 min to 30 min, and preferably 1 min to 15 min. The temperature in regular drying step B2 is preferably not less than 130° C. and not more than 180° C., and more preferably not less than 130° C. and not more than 160° C. The time of regular drying step B2 is, for example, 0.5 min to 30 min, and preferably 1 min to 15 min.

By regulating the kind and the amount of the surfactant, and regulating the stirring rate and the stirring time during mechanical stirring, there can be obtained the foamed sheet having an average cell diameter in the range of 10 to 200 μm.

By regulating the amount of the gas component entrapped in the emulsion resin composition during mechanical stirring, there can be obtained the foamed sheet having a density of 0.2 to 0.7 g/cm³.

The foamed sheet of the present invention may have a pressure-sensitive adhesive layer (adhesive layer) on one surface or on both surfaces of the foamed sheet. A pressure-sensitive adhesive constituting the pressure-sensitive adhesive layer is not particularly limited, and may be any of an acrylic pressure-sensitive adhesive, a rubber-based pressure-sensitive adhesive, a silicone-based pressure-sensitive adhesive and the like. In the case of providing the pressure-sensitive adhesive layer, a release liner to protect the pressure-sensitive adhesive layer until its usage may be laminated on its surface. In the case where the foamed sheet constituting the foamed sheet according to the present invention exhibits slight tackiness, members and the like can be fixed even without providing the pressure-sensitive adhesive layer.

When the foamed sheet of the present invention, in which the shear adhesive strength (measurement condition: 23° C., tension rate 50 mm/min) of at least one side of the foamed sheet to a SUS304BA plate is 0.5 N/100 mm² or more, is used as a laminate with another member (e.g., a heat conductive layer), an effect that such another member is neither detached nor shifted out of place may be obtained, even without providing the foamed sheet with an adhesive layer. Further, since it is unnecessary to provide an adhesive layer, the thickness of the laminate of the foamed sheet and another member can be reduced so that it can contribute to further reduction of the thickness of an electric or electronic device on to which the laminate is mounted. Furthermore, the production efficiency of the laminate can be improved and the cost may be reduced. Examples of the layer constitution of the laminate of the foamed sheet of the present invention and another member (for example, heat conductive layer) include other member/foamed sheet, other member/pressure-sensitive adhesive/foamed sheet, foamed sheet/other member/foamed sheet, and foamed sheet/pressure-sensitive adhesive layer/other member/pressure-sensitive adhesive layer/foamed sheet.

In a case where the foamed sheet of the present invention has tackiness, the shear adhesive strength of the foamed sheet of the present invention to a SUS304BA plate may be adjusted, for example, by selecting the types and the composition ratio of monomers composing a resin material (polymer) that constitutes the foamed sheet of the present invention. For example, when a monomer, which homopolymer has a Tg of less than −10° C. (for example, −70° C. or more and less than −10° C., preferably from −70° C. to −12° C., and more preferably from −65° C. to −15° C.), is used as a monomer composing a resin material (a polymer such as an acrylic polymer) constituting the foamed sheet of the present invention in an amount of, for example, 70 to 98% by weight (the lower limit is preferably 75% by weight and the upper limit is preferably 97% by weight) with respect to the total monomer component (total amount of monomers) composing the resin material (a polymer such as an acrylic polymer), and the type and the amount of another monomer are selected appropriately, the shear adhesive strength of the foamed sheet to a SUS304BA plate can be 0.5 N/100 mm² or more.

The lower limit of the shear adhesive strength of the foamed sheet of the present invention to a SUS304BA plate is preferably 0.5 N/100 mm², and more preferably 0.7 N/100 mm². There is no particular restriction on the upper limit of the shear adhesive strength, and is, for example, 100 N/100 mm².

The foamed sheet of the present invention may be distributed on the market as a wound body (roll) wound up into a roll form.

The foamed sheet of the present invention is excellent in impact absorption, and still excellent in resistance to repeated impacts. For this reason, it is useful for example as a member for an electric or electronic device, particularly, as an impact absorbing sheet, used in an electric or electronic device for mounting various members or parts (for example, optical member) on to a predetermined region (for example, its housing). Since the foamed sheet of the present invention is used in the electric or electronic device of the present invention, the device is resistant to break due to an impact at an accidental fall, and also resistant to break due to repeated impacts. Further, since the foamed sheet of the present invention is excellent in impact absorption, and is excellent in resistance to repeated impacts, even when the thickness is very thin, the electric or electronic device of the present invention is resistant to break due to an impact at an accidental fall, and also resistant to break due to repeated impacts, even when it is miniaturized, or slimmed. In this regard, an “electric or electronic device” means a device corresponding to at least either of an electric device and an electronic device.

Examples of an optical member that can be mounted by using the foamed sheet of the present invention include an image display member (especially a small-sized image display member) mounted on an image display device, such as a liquid crystal display, an electroluminescent display, and a plasma display; and a display member such as a touch screen mounted on an apparatus for mobile telecommunication, such as a so-called “mobile phone”, a “smart phone”, and a “portable information terminal”; as well as a camera, and lenses (especially a small camera and lenses).

In the electric or electronic device of the present invention, the foamed sheet of the present invention is used. Such the electric or electronic device is for example an electric or electronic device provided with a display member and having a structure in which the foamed sheet is sandwiched between the housing of the electric or electronic device and the display member. Examples of the electric or electronic device include an device for mobile telecommunication, such as a so-called “mobile phone”, a “smart phone”, and a “portable information terminal”.

In addition, when the foamed sheet of the present invention is used in a device with touch screen, even if a display panel or a touch screen is bent or deformed due to a touch operation by the user, the sheet can effectively disperse or absorb forces generated due to the deformation. Therefore, the foamed sheet of the present invention can suppress to the highest degree occurrence of display unevenness at the display unit (a blur in a wave pattern), which may appear due to application of stress to the display panel. Consequently, the foamed sheet of the present invention may be favorably used in a device with touch screen.

The device with touch screen means a device having a display panel and equipped with a touch screen. There is no particular restriction on the device with touch screen, and examples thereof include a mobile phone, a smart phone, a portable information terminal (PDA), a tablet computer, various personal computers (PC) such as a desktop type, a notebook type, and a tablet type, various displays (monitors), such as a plasma display, a liquid crystal display, and an electroluminescent display (organic EL display), a portable game machine, a digital audio player, an electronic book reader (device for reading electronic books, or terminal dedicated to electronic books), a wearable computer (wearable device), a digital signage (electronic signage), an automatic teller machine (ATM), an automatic ticketing machine or vending machine for selling ticket, various tradable coupons, beverage, food, tobacco, magazine, newspaper, or the like, a TV receiving set (television), and an electronic blackboard (interactive white board).

In the device with touch screen of the present invention, the foamed sheet of the present invention is used. Examples of such the device with touch screen include a device having the foamed sheet, a display panel, and a touch screen, wherein the foamed sheet is placed in a space on the back side of the display panel. Since the foamed sheet of the present invention is used, the device with touch screen of the present invention is resistant to break due to an impact at an accidental fall, and also resistant to break due to repeated impacts. Further, since the foamed sheet of the present invention is excellent in impact absorption, and is excellent in resistance to repeated impacts, even when the thickness is very thin, the device with touch screen of the present invention is resistant to break due to an impact at an accidental fall, and also resistant to break due to repeated impacts, even when it is miniaturized, or slimmed. Furthermore, in the device with touch screen of the present invention, occurrence of display unevenness in the display unit to be caused by a touch operation by the user is highly suppressed.

### EXAMPLES

The present invention will be described below in more detail with reference to Examples, provided that the present invention is not restricted in any way by the Examples. Meanwhile, “%” representing a content means % by weight unless otherwise specified. Further, a content (parts by weight) is always a value in terms of solid content (nonvolatile content).

### Example 1

In a disperser (“ROBOMIX”, manufactured by PRIMIX Corp.), 100 parts by weight of an acrylic emulsion solution (solid content 57%, a butyl acrylate/methyl methacrylate/acrylonitrile/acrylic acid copolymer (weight ratio: 91/4/3/2)), 1.5 parts by weight of a fatty acid ammonium surfactant (an aqueous dispersion of ammonium stearate, solid content 33%) (surfactant A), 1.0 part by weight of a carboxybetaine amphoteric surfactant (“AMOGEN CB-H”, produced by Dai-ichi Kogyo Seiyaku Co., Ltd.) (surfactant B), 0.35 part by weight of an oxazoline crosslinking agent (“EPOCROS WS-500”, produced by Nippon Shokubai Co., Ltd., solid content 39%), 0.78 part by weight of a poly(acrylic acid)-based thickener (an ethyl acrylate/acrylic acid copolymer (acrylic acid 20%), solid content 28.7%), and 1.0 part by weight of a lubricant (a modified silicone oil “X-22-163C”, produced by Shin-Etsu Chemical Co., Ltd.) were stirred, mixed, and foamed. The foamed composition was applied on a release-treated PET (polyethylene terephthalate) film (thickness: 38 μm, trade name “MRF #38”, produced by Mitsubishi Plastics, Inc.) and dried at 80° C. for 5 min and then at 140° C. for 5 min to obtain a foam (foamed sheet) with an open-cell structure having a thickness of 150 μm, a density of 0.31 g/cm³, the maximum cell diameter of 110 μm, the minimum cell diameter of 20 μm, and an average cell diameter of 45 μm.

### Example 2

In a disperser (“ROBOMIX”, manufactured by PRIMIX Corp.), 100 parts by weight of an acrylic emulsion solution (solid content 57%, a butyl acrylate/methyl methacrylate/acrylonitrile/acrylic acid copolymer (weight ratio: 91/4/3/2)), 1.5 parts by weight of a fatty acid ammonium surfactant (an aqueous dispersion of ammonium stearate, solid content 33%) (surfactant A), 1.0 part by weight of a carboxybetaine amphoteric surfactant (“AMOGEN CB-H”, produced by Dai-ichi Kogyo Seiyaku Co., Ltd.) (surfactant B), 2.0 parts by weight of an oxazoline crosslinking agent (“EPOCROS WS-500”, produced by Nippon Shokubai Co., Ltd., solid content 39%), 1.5 parts by weight of a poly(acrylic acid)-based thickener (an ethyl acrylate/acrylic acid copolymer (acrylic acid 20%), solid content 28.7%), and 1.0 part by weight of a lubricant (a modified silicone oil “X-22-163C”, produced by Shin-Etsu Chemical Co., Ltd.) were stirred, mixed, and foamed. The foamed composition was applied on a release-treated PET (polyethylene terephthalate) film (thickness: 38 μm, trade name “MRF #38”, produced by Mitsubishi Plastics, Inc.) and dried at 80° C. for 5 min and then at 140° C. for 5 min to obtain a foam (foamed sheet) with an open-cell structure having a thickness of 200 μm, a density of 0.25 g/cm³, the maximum cell diameter of 110 μm, the minimum cell diameter of 20 μm, and an average cell diameter of 40 μm.

### Example 3

In a disperser (“ROBOMIX”, manufactured by PRIMIX Corp.), 100 parts by weight of an acrylic emulsion solution (solid content 57%, a butyl acrylate/methyl methacrylate/acrylonitrile/acrylic acid copolymer (weight ratio: 91/4/3/2)), 1.5 parts by weight of a fatty acid ammonium surfactant (an aqueous dispersion of ammonium stearate, solid content 33%) (surfactant A), 1.0 part by weight of a carboxybetaine amphoteric surfactant (“AMOGEN CB-H”, produced by Dai-ichi Kogyo Seiyaku Co., Ltd.) (surfactant B), 1.0 part by weight of an oxazoline crosslinking agent (“EPOCROS WS-500”, produced by Nippon Shokubai Co., Ltd., solid content 39%), 1.0 part by weight of a poly(acrylic acid)-based thickener (an ethyl acrylate/acrylic acid copolymer (acrylic acid 20%), solid content 28.7%), and 1.0 part by weight of a lubricant (a modified silicone oil “X-22-163C”, produced by Shin-Etsu Chemical Co., Ltd.) were stirred, mixed, and foamed. The foamed composition was applied on a release-treated PET (polyethylene terephthalate) film (thickness: 38 μm, trade name “MRF #38”, produced by Mitsubishi Plastics, Inc.) and dried at 80° C. for 5 min and then at 140° C. for 5 min to obtain a foam (foamed sheet) with an open-cell structure having a thickness of 80 μm, a density of 0.35 g/cm³, the maximum cell diameter of 60 μm, the minimum cell diameter of 20 μm, and an average cell diameter of 40 μm.

### Example 4

In a disperser (“ROBOMIX”, manufactured by PRIMIX Corp.), 100 parts by weight of an acrylic emulsion solution (solid content 57%, a butyl acrylate/methyl methacrylate/acrylonitrile/acrylic acid copolymer (weight ratio: 91/4/3/2)), 1.5 parts by weight of a fatty acid ammonium surfactant (an aqueous dispersion of ammonium stearate, solid content 33%) (surfactant A), 1.0 part by weight of a carboxybetaine amphoteric surfactant (“AMOGEN CB-H”, produced by Dai-ichi Kogyo Seiyaku Co., Ltd.) (surfactant B), 1.0 part by weight of an oxazoline crosslinking agent (“EPOCROS WS-500”, produced by Nippon Shokubai Co., Ltd., solid content 39%), 1.0 part by weight of a poly(acrylic acid)-based thickener (an ethyl acrylate/acrylic acid copolymer (acrylic acid 20%), solid content 28.7%), and 1.0 part by weight of a lubricant (a modified silicone oil “X-22-163C”, produced by Shin-Etsu Chemical Co., Ltd.) were stirred, mixed, and foamed. The foamed composition was applied on a release-treated PET (polyethylene terephthalate) film (thickness: 38 μm, trade name “MRF #38”, produced by Mitsubishi Plastics, Inc.) and dried at 80° C. for 5 min and then at 140° C. for 5 min to obtain a foam (foamed sheet) with an open-cell structure having a thickness of 300 μm, a density of 0.24 g/cm³, the maximum cell diameter of 120 μm, the minimum cell diameter of 30 μm, and an average cell diameter of 50 μm.

### Example 5

In a disperser (“ROBOMIX”, manufactured by PRIMIX Corp.), 100 parts by weight of an acrylic emulsion solution (solid content 57%, a butyl acrylate/methyl methacrylate/acrylonitrile/acrylic acid copolymer (weight ratio: 91/4/3/2)), 1.5 parts by weight of a fatty acid ammonium surfactant (an aqueous dispersion of ammonium stearate, solid content 33%) (surfactant A), 1.0 part by weight of a carboxybetaine amphoteric surfactant (“AMOGEN CB-H”, produced by Dai-ichi Kogyo Seiyaku Co., Ltd.) (surfactant B), 1.0 part by weight of an oxazoline crosslinking agent (“EPOCROS WS-500”, produced by Nippon Shokubai Co., Ltd., solid content 39%), 1.0 part by weight of a poly(acrylic acid)-based thickener (an ethyl acrylate/acrylic acid copolymer (acrylic acid 20%), solid content 28.7%), 1.0 part by weight of a lubricant (a modified silicone oil “X-22-163C”, produced by Shin-Etsu Chemical Co., Ltd.), and 0.9 part by weight of a filler (silica particles, average particle diameter: 1 μm) were stirred, mixed, and foamed. The foamed composition was applied on a release-treated PET (polyethylene terephthalate) film (thickness: 38 μm, trade name “MRF #38”, produced by Mitsubishi Plastics, Inc.) and dried at 80° C. for 5 min and then at 140° C. for 5 min to obtain a foam (foamed sheet) with an open-cell structure having a thickness of 150 μm, a density of 0.30 g/cm³, the maximum cell diameter of 110 μm, the minimum cell diameter of 20 μm, and an average cell diameter of 45 μm.

### Example 6

In a disperser (“ROBOMIX”, manufactured by PRIMIX Corp.), 100 parts by weight of an acrylic emulsion solution (solid content 57%, a butyl acrylate/methyl methacrylate/acrylonitrile/acrylic acid copolymer (weight ratio: 91/4/3/2)), 1.5 parts by weight of a fatty acid ammonium surfactant (an aqueous dispersion of ammonium stearate, solid content 33%) (surfactant A), 1.0 part by weight of a carboxybetaine amphoteric surfactant (“AMOGEN CB-H”, produced by Dai-ichi Kogyo Seiyaku Co., Ltd.) (surfactant B), 1.0 part by weight of an oxazoline crosslinking agent (“EPOCROS WS-500”, produced by Nippon Shokubai Co., Ltd., solid content 39%), 1.0 part by weight of a poly(acrylic acid)-based thickener (an ethyl acrylate/acrylic acid copolymer (acrylic acid 20%), solid content 28.7%), 1.0 part by weight of a lubricant (a modified silicone oil “X-22-163C”, produced by Shin-Etsu Chemical Co., Ltd.), and 5 parts by weight of a filler (silica particles, average particle diameter: 1 μm) were stirred, mixed, and foamed. The foamed composition was applied on a release-treated PET (polyethylene terephthalate) film (thickness: 38 μm, trade name “MRF #38”, produced by Mitsubishi Plastics, Inc.) and dried at 80° C. for 5 min and then at 140° C. for 5 min to obtain a foam (foamed sheet) with an open-cell structure having a thickness of 150 μm, a density of 0.30 g/cm³, the maximum cell diameter of 110 μm, the minimum cell diameter of 20 μm, and an average cell diameter of 45 μm.

### Comparative Example 1

In a disperser (“ROBOMIX”, manufactured by PRIMIX Corp.), 100 parts by weight of an acrylic emulsion solution (solid content 55%, an ethyl acrylate/butyl acrylate/acrylonitrile copolymer (weight ratio: 45/48/7)), 1.5 parts by weight of a fatty acid ammonium surfactant (an aqueous dispersion of ammonium stearate, solid content 33%) (surfactant A), 1.0 part by weight of a carboxybetaine amphoteric surfactant (“AMOGEN CB-H”, produced by Dai-ichi Kogyo Seiyaku Co., Ltd.) (surfactant B), 0.35 part by weight of an oxazoline crosslinking agent (“EPOCROS WS-500”, produced by Nippon Shokubai Co., Ltd., solid content 39%), and 0.78 part by weight of a poly(acrylic acid)-based thickener (an ethyl acrylate/acrylic acid copolymer (acrylic acid 20%), solid content 28.7%) were stirred, mixed, and foamed. The foamed composition was applied on a release-treated PET (polyethylene terephthalate) film (thickness: 38 μm, trade name “MRF #38”, produced by Mitsubishi Plastics, Inc.) and dried at 80° C. for 5 min and then at 140° C. for 5 min to obtain a foam (foamed sheet) with an open-cell structure having a thickness of 150 μm, a density of 0.32 g/cm³, the maximum cell diameter of 110 μm, the minimum cell diameter of 20 μm, and an average cell diameter of 45 μm.

### Comparative Example 2

In a disperser (“ROBOMIX”, manufactured by PRIMIX Corp.), 100 parts by weight of an acrylic emulsion solution (solid content 55%, an ethyl acrylate/butyl acrylate/acrylonitrile copolymer (weight ratio: 45/48/7)), 1.5 parts by weight of a fatty acid ammonium surfactant (an aqueous dispersion of ammonium stearate, solid content 33%) (surfactant A), 1.0 part by weight of a carboxybetaine amphoteric surfactant (“AMOGEN CB-H”, produced by Dai-ichi Kogyo Seiyaku Co., Ltd.) (surfactant B), 0.35 part by weight of an oxazoline crosslinking agent (“EPOCROS WS-500”, produced by Nippon Shokubai Co., Ltd., solid content 39%), and 25 parts by weight of a filler (silica particles, average particle diameter: 5 μm) were stirred, mixed, and foamed. The foamed composition was applied on a release-treated PET (polyethylene terephthalate) film (thickness: 38 μm, trade name “MRF #38”, produced by Mitsubishi Plastics, Inc.) and dried at 80° C. for 5 min and then at 140° C. for 5 min to obtain a foam (foamed sheet) with an open-cell structure having a thickness of 150 μm, a density of 0.31 g/cm³, the maximum cell diameter of 110 μm, the minimum cell diameter of 20 μm, and an average cell diameter of 45 μm.

### Comparative Example 3

In a double-screw kneader, 100 parts by weight of a block copolymer of poly(butylene terephthalate) as a hard segment and a polyether as a soft segment (trade name “PELPRENE P-90 BD”, produced by Toyobo Co., Ltd., melt flow rate at 230° C.: 3.0 g/10 min, melting point: 204° C.), 5 parts by weight of an acrylic lubricant (trade name “METABLEN L-1000”, produced by Mitsubishi Rayon Co., Ltd.), 1 part by weight of hard clay surface-treated with a silane coupling agent (trade name “ST-301”, produced by Shiraishi Calcium Kaisha, Ltd.), 5 parts by weight of carbon black (trade name “Asahi #35”, produced by Asahi Carbon Co., Ltd.), and 2 parts by weight of an epoxy-based modifier (epoxy-modified acrylic polymer, weight average molecular weight (Mw): 50000, epoxy equivalent: 1200 g/eq, viscosity: 2850 mPa·s) were kneaded at a temperature of 220° C., extruded in the form of a strand, cooled with water, and chopped into the form of pellets. The pellets were charged into a single-screw extruder, and in an atmosphere at 240° C. a carbon dioxide gas was injected under a pressure of 17 MPa (13 MPa after the injection). When the melt is sufficiently saturated with the carbon dioxide gas, the same is cooled down to a temperature suitable for foaming, and extruded through a die to yield a polyester elastomer foam in a sheet form with a thickness of 2.0 mm. The yielded foam was sliced to yield a foam (foamed sheet) with an open-cell structure having a thickness of 200 μm, a density of 0.07 g/cm³, the maximum cell diameter of 80 μm, the minimum cell diameter of 20 μm, and an average cell diameter of 30 μm.

### <Evaluation>

The following evaluations were conducted on the foams (foamed sheets) obtained in Examples and Comparative Examples. The results are shown in Table 1. The contents (parts by weight) of the respective components in Examples and Comparative Examples [in terms of solid contents (nonvolatile contents)] are also shown in Table 1.

### (Average Cell Diameter)

An enlarged image of a cross section of a foam was scanned by a low-vacuum pressure scanning electron microscope (“S-3400N scanning electron microscope”, manufactured by Hitachi High-Technologies Science Systems), and an image analysis was performed to determine an average cell diameter (μm). The analysis was performed on 10 to 20 bubbles. The minimum cell diameter (μm) and the maximum cell diameter (μm) of a foamed sheet were determined in the same manner as the average cell diameter.

### (Density)

A foam (foamed sheet) is punched out with a punching blade of 100 mm×100 mm, and the sizes of the punched-out sample are measured. The thickness is measured with a 1/100 dial gauge using a probe tip with a diameter (ϕ) of 20 mm. From these values, the volume of the foam was calculated.

Next, the weight of the foam is measured with an even balance having the minimum scale of 0.01 g or more. From these values, the density (g/cm³) of the foam was calculated.

### (Dynamic Viscoelasticity)

A temperature dispersion test was conducted with a rheometer (“ARES 2KFRTN1-FCO”, manufactured by TA Instruments Japan) in a film tension test mode at an angular frequency of 1 rad/s and a rate of temperature increase of 5° C./min. During the test, the temperature (° C.) and the intensity (maximum value) of the peak top of the loss tangent (tan δ), which is the ratio of the storage modulus E′ to the loss modulus E″, were measured.

The peak top temperature (° C.) of the loss tangent (tan δ) of a foam was entered in the column of “tan δ temperature” of Table 1, the intensity (maximum value) of the peak top was entered in the column of “maximum tan δ”, and the value obtained by dividing the intensity (maximum value) of the peak top by the density of the foam, [which corresponds to the intensity of the peak top (maximum value) of tan δ of the material itself constituting the foam (bubbles are excluded)], was entered in the column of “maximum tan δ/density”.

### (Initial Elastic Modulus (in 0° C. Environment))

A foam was cut into a sheet-like test piece with a width of 10 mm and a length of 40 mm. The test piece was subjected to a tensile test using a rheometer (“RSA-III”, manufactured by TA Instruments Japan) under the conditions that the measuring temperature was 0° C. and the tension rate was 300 mm/min. The initial elastic modulus (N/mm²) was calculated from the slope at 10% strain. The evaluation result was entered in the column of “initial elastic modulus” in Table 1.

### (Thickness Recovery Rate)

A foam was cut into a sheet-like test piece with a width of 25 mm and a length of 40 mm. Using an electromagnetic force micro material tester (trade name Microservo “MMT-250”, manufactured by Shimadzu Corporation), a load of 1 kg (100 g per 1 cm²) was applied in the thickness direction on the test piece, and the compressed state was maintained for 120 sec in an atmosphere of 23° C. In the atmosphere of 23° C., the compressed state was released and the thickness recovery behavior (thickness change, thickness recovery) of the foam was photographed with a high speed camera, and the thickness of the foam at 0.5 sec after the release from the compressed state was determined from the captured images. Then, the recovery rate was calculated from the following formula. The evaluation result was entered in the column of “thickness recovery rate” in Table 1.

Thickness recovery rate (%)=(Thickness at 0.5 sec after the release from the compressed state)/(Original thickness)×100

### (Resiliency at 50% Compression (Opposing Repulsive Load at 50% Compression, Compressive Load at 50% Compression))

It was measured according to the compressive hardness measurement method stipulated in JIS K 6767.

A foam was cut into a sheet-like test piece with a width of 30 mm and a length of 30 mm. Next, the test piece was compressed in the thickness direction at a compression rate of 10 mm/min to a compression ratio of 50%, and the then stress (N) was measured and reduced to the value per unit area (1 cm²), which was regarded as resiliency (N/cm²). The evaluation result was entered in the column of “load at 50% compression” in Table 1.

### (Impact Absorption Test)

An impact absorption test was carried out using the pendulum impact testing machine (impact test machine) described above (see FIGS. 1 and 2). With respect to the foamed sheets (sample size: 20 mm×20 mm) obtained in Examples and Comparative Examples impact tests were conducted, in which a 66 g steel ball was released at a swing angle of 40° to collide the sheet successively 5 times at intervals of 1 sec, and the impulsive force (N) at each collision was measured. The evaluation results were entered in the columns of “impact absorption test” in Table 1.

With respect to the impulsive force (N) at each collision, the number of collisions was plotted on the x-axis, and the impulsive force (N) was plotted on the y-axis in total 5 points. From the plotted 5 points a linear approximation line was obtained using the least squares method, and the inclination thereof was found. The evaluation result was entered in the column of “slope of repeated impulsive forces” in Table 1.

### (Thickness Recovery Rate at High Temperature)

A foam was cut into a sheet-like test piece with a width of 30 mm and a length of 30 mm. The thickness of the test piece was accurately measured, and it was regarded as the thickness a. Next, the test piece was compressed between 2 sheets of compression plate (aluminum plates) with a jig from both the sides in the thickness direction to 50% of the original thickness (namely 50% compressed state) using a spacer (the spacer thickness c), and stored at a humidity of 50%, a temperature of 80° C. while keeping the compressed state for 22 hours. After elapse of 22 hours, the same was stored in an atmosphere of 23° C. for 2 hours, then released from the compressed state, and left standing for 24 hours. After standing, the thickness of the test piece was measured accurately, and regarded as the thickness b.

The thickness recovery rate (%) at high temperature was calculated from the thickness a, the thickness b, and the thickness c according to the following formula. The evaluation result was entered in the column of “thickness recovery rate at high temperature” in Table 1.

Thickness recovery rate at high temperature (%)=(1−(thickness a−thickness b)/(thickness a−thickness c))×100

The thickness a and the thickness b were measured in an environment at a temperature of 23±2° C., and a relative humidity of 50±5%.

TABLE 1

| | | | | Example 1 | Example 2 | Example 3 | Example 4 | Example 5 |
|---|---|---|---|---|---|---|---|---|
| Composition | Acrylic emulsion solution | | Content (part) | 100 | 100 | 100 | 100 | 100 |
| | Crosslinking agent | | Content (part) | 0.35 | 2.0 | 1.0 | 1.0 | 1.0 |
| | Thickener | | Content (part) | 0.78 | 1.5 | 1.0 | 1.0 | 1.0 |
| | Surfactant A | | Content (part) | 1.5 | 1.5 | 1.5 | 1.5 | 1.5 |
| | Surfactant B | | Content (part) | 1.0 | 1.0 | 1.0 | 1.0 | 1.0 |
| | Filler | | Content (part) | — | — | — | — | 0.9 |
| | Lubricant | | Content (part) | 1.0 | 1.0 | 1.0 | 1.0 | 1.0 |
| Foamed sheet | Thickness | | μm | 150 | 200 | 80 | 300 | 150 |
| | Maximum cell diameter | | μm | 110 | 110 | 60 | 120 | 110 |
| | Minimum cell diameter | | μm | 20 | 20 | 20 | 30 | 20 |
| | Average cell diameter | | μm | 45 | 40 | 40 | 50 | 45 |
| | Density | | g/cm³ | 0.31 | 0.25 | 0.35 | 0.24 | 0.30 |
| | Viscoelasticity | Tan δ | ° C. | −22.30 | −22.30 | −22.30 | −22.30 | −22.10 |
| | | temperature | | | | | | |
| | | Maximum tan δ | — | 0.89 | 0.90 | 0.89 | 0.89 | 0.90 |
| | | Maximum tan δ/ | (g/cm³)⁻¹ | 2.87 | 3.60 | 2.54 | 3.71 | 3.00 |
| | | Density | | | | | | |
| | Initial elastic | In 0° C. | N/mm² | 1.40 | 0.90 | 1.80 | 0.80 | 1.50 |
| | modulus | environment | | | | | | |
| | Thickness | 0.5 sec after | % | 92 | 90 | 91 | 92 | 91 |
| | recovery rate | unloading | | | | | | |
| | Load at 50% compression | | N/cm² | 2.40 | 2.00 | 3.10 | 1.91 | 2.82 |
| | Impact | 1st | N | 738 | 700 | 755 | 650 | 728 |
| | absorption | 2nd | | 739 | 701 | 756 | 651 | 732 |
| | test | 3rd | | 738 | 702 | 757 | 650 | 729 |
| | | 4th | | 737 | 700 | 756 | 652 | 730 |
| | | 5th | | 739 | 701 | 755 | 651 | 728 |

| | | | | | | |
|---|---|---|---|---|---|---|
| Slope of repeated impulsive forces | — | 0.15 | 0.10 | 0.10 | 0.10 | 0.10 |
| Thickness recovery rate at high | % | 96 | 95 | 95 | 96 | 97 |
| temperature | | | | | | |

| | | | Comparative | Comparative | Comparative |
|---|---|---|---|---|---|
| | | Example 6 | Example 1 | Example 2 | Example 3 |
| Composition | Acrylic emulsion solution | 100 | 100 | 100 | — |
| | Crosslinking agent | 1.0 | 0.35 | 0.35 | — |
| | Thickener | 1.0 | 0.78 | — | — |
| | Surfactant A | 1.5 | 1.5 | 1.5 | — |
| | Surfactant B | 1.0 | 1.0 | 1.0 | — |
| | Filler | 5.0 | — | 25 | — |
| | Lubricant | 1.0 | — | — | — |
| Foamed sheet | Thickness | 150 | 150 | 150 | 200 |
| | Maximum cell diameter | 110 | 110 | 110 | 80 |
| | Minimum cell diameter | 20 | 20 | 20 | 20 |
| | Average cell diameter | 45 | 45 | 45 | 30 |
| | Density | 0.30 | 0.32 | 0.31 | 0.07 |

| Viscoelasticity | Tan δ | −21.50 | −8.24 | −5.17 | — |
|---|---|---|---|---|---|
| | temperature | | | | |
| | Maximum tan δ | 0.91 | 0.97 | 1.09 | — |
| | Maximum tan δ/ | 3.03 | 3.03 | 3.52 | — |
| | Density | | | | |
| Initial elastic | In 0° C. | 1.60 | 4.80 | 5.10 | — |
| modulus | environment | | | | |
| Thickness | 0.5 sec after | 92 | 86 | 88 | 88 |
| recovery rate | unloading | | | | |
| Load at 50% compression | | 3.01 | 2.95 | 6.49 | 2.50 |
| Impact | 1st | 698 | 750 | 676 | 665 |
| absorption | 2nd | 701 | 757 | 705 | 670 |
| test | 3rd | 699 | 778 | 710 | 671 |
| | 4th | 700 | 787 | 725 | 672 |
| | 5th | 701 | 792 | 770 | 675 |

| | | | | |
|---|---|---|---|---|
| Slope of repeated impulsive forces | 0.15 | 11.60 | 20.80 | 10.00 |
| Thickness recovery rate at high | 98 | 93 | 93 | 60 |
| temperature | | | | |

As shown in Table 1, with respect to the foamed sheets of Examples, the average cell diameters were from 10 to 200 μm, the resiliencies when the thickness was compressed by 50% were 6.0 N/cm² or less, and the thickness recovery rates after 0.5 sec were 90% or more. Further, they exhibited high impact absorption capacity and even at the 5th collision almost the same impact absorption capacity as at the 1st collision. In contrast, with respect to the foamed sheets of Comparative Examples 1 to 3, the thickness recovery rate after 0.5 sec did not reach 90%, and the impact absorption capacity at the 5th collision was greatly reduced compared to the 1st collision.

### REFERENCE SIGNS LIST

1 Pendulum impact testing machine (Impact test machine)
2 Test piece (foamed sheet)
3 Holding member
4 Impact loading member
5 Pressure sensor
11 Fixing jig
12 Holding jig
16 Pressure adjustment means
20 Pillar
21 Arm
22 End of support shaft (shaft)
23 Support shaft (shaft)
24 Impacting object
25 Electromagnet
28 Substrate
a Swing angle

1. A foamed sheet having an average cell diameter of 10 to 200 μm, a resiliency of 6.0 N/cm² or less when compressed to 50% of an original thickness thereof, and a thickness recovery rate defined by the following equation of 90% or more:
thickness recovery rate (%)=(thickness 0.5 seconds after compressed state is released)/(original thickness)×100
original thickness: a thickness of the foamed sheet before a load is applied,
thickness 0.5 seconds after compressed state is released: a thickness of the foamed sheet after a compressed state in which a load of 100 g/cm² is applied to the foamed sheet is kept for 120 seconds followed by release of the foamed sheet from the compression and an elapse of 0.5 seconds from the release.

2. The foamed sheet according to claim 1, having a thickness of 30 to 1000 μm and a density of 0.2 to 0.7 g/cm³.

3. The foamed sheet according to claim 1, wherein a peak top of a loss tangent (tan δ) thereof appears within a range not less than −60° C. and not more than 20° C., wherein the tan δ is a ratio of a loss modulus to a storage modulus at an angular frequency of 1 rad/s in a dynamic viscoelasticity measurement.

4. The foamed sheet according to claim 1, having an increment of an impulsive force at a fifth collision from an impulsive force at a first collision of 5% or less, when an impacting object is allowed to collide five times continuously at one-second intervals against a substrate of a structure composed of the substrate and the foamed sheet in an impact absorption test using a pendulum impact testing machine.

5. The foamed sheet according to claim 1, comprising a crosslinking agent and a silicone compound.

6. The foamed sheet according to claim 1, having a content insoluble to methyl ethyl ketone as a solvent of 80% or more by weight.

7. The foamed sheet according to claim 1, wherein a maximum value of the loss tangent (tan δ) within a range not less than −60° C. and not more than 20° C. is 0.2 or more.

8. The foamed sheet according to claim 1, having a thickness recovery rate at a high temperature defined below of 50% or more:
thickness recovery rate at a high temperature: a ratio of a thickness 24 hours after releasing a compressed state at a high temperature to an original thickness, wherein the foamed sheet is compressed in an atmosphere at 80° C. in a thickness direction to 50% of the original thickness thereof and left for 22 hours, then left standing in an atmosphere at 23° C. for 2 hours, and then released from compression.

9. The foamed sheet according to claim 1, wherein an acrylic polymer is used as a resin material.

10. The foamed sheet according to claim 1, wherein at least one side thereof has a shear adhesive strength (23° C., tension rate 50 mm/min) to a SUS304BA plate of 0.5 N/100 mm² or more.

11. The foamed sheet according to claim 1, wherein the foamed sheet is a mechanically foamed product of an emulsion resin composition.

12. The foamed sheet according to claim 1, having a pressure-sensitive adhesive layer on one or both of sides thereof.

13. The foamed sheet according to claim 1, for use as an impact absorbing sheet for an electric or electronic device.

14. The foamed sheet according to claim 1, for use in a device with touch screen.

15. An electric or electronic device, having the foamed sheet according to claim 1.

16. The electric or electronic device according to claim 15, comprising a display member, wherein the electric or electronic device has a structure in which the foamed sheet is sandwiched between a housing of the electric or electronic device and the display member.

17. A device with touch screen, having the foamed sheet according to claim 14.

18. The device with touch screen according to claim 17, having the foamed sheet, a display panel, and a touch screen, wherein the foamed sheet is arranged in a space on a back side of the display panel.
